(19) United States
(12) Patent Application Publication
(10) Pub. No.: US 2026/0025339 A1
(43) Pub. Date: Jan. 22, 2026

(54) PROACTIVE PACKET DROPPING FOR EXTENDED REALITY TRAFFIC FLOWS

(71) Applicant: Apple Inc., Cupertino, CA (US)

(72) Inventors: Ping-Heng Kuo, London (GB); Ralf Rossbach, Munich (DE); Fangli Xu, Beijing (CN)

(21) Appl. No.: 18/992,770

(22) PCT Filed: Jul. 26, 2022
(86) PCT No.: PCT/CN2022/107970

§ 371 Date: Jan. 9, 2025

(51) Int. Cl. H04L 47/32; H04W 72/1268

(52) U.S. Cl. CPC H04L 47/32; H04W 72/1268

(57) ABSTRACT

A method of wireless communication by a user equipment (UE) includes receiving at least one indication that at least one logical channel (LCH) is configured to support a proactive packet dropping behavior; determining, in accord with a logical channel prioritization (LCP) procedure, whether the at least one LCH will be mapped to an uplink grant; when the LCH will be mapped to the uplink grant, constructing a first medium access control (MAC) protocol data unit (PDU), for transmission on the uplink grant, that excludes at least one type of MAC control element (CE) or excludes data from at least one type of LCH; and when none of the at least one LCH will be mapped to the uplink grant, constructing, in accord with the LCP procedure, a second MAC PDU for transmission on the uplink grant.

### TECHNICAL FIELD

This application relates generally to wireless communication systems, including proactive packet dropping for extended reality (XR) traffic flows.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In some deployments, the E-UTRAN may also implement NR RAT. In some deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows a couple of protocol data unit (PDU) sets that may be mapped to quality of service (QoS) or XR traffic flows.

FIG. 2 shows an example medium access control (MAC) PDU (or transport block (TB)) that may be used to transmit one or more MAC control elements (CEs) or data packets.

FIG. 3 shows an example method of wireless communication by a UE, which method may be used to proactively drop non-transmitted data packets of a PDU set under some conditions.

FIG. 4 shows an example implementation of the method described with reference to FIG. 3.

FIG. 5 shows another example method of wireless communication by a UE, which method may be used to support proactive packet dropping behavior for one or more logical channels.

FIG. 6 shows an example implementation of the method described with reference to FIG. 5.

FIG. 7 shows an example method of wireless communication by a base station, which method may be used to support proactive packet dropping behavior for one or more logical channels of a UE.

FIG. 8 illustrates an example architecture of a wireless communication system, according to embodiments described herein.

FIG. 9 illustrates a system for performing signaling between a wireless device and a network device, according to embodiments described herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

In 3GPP Release 18, 5G NR RAT needs to be enhanced to support special services such as XR services. XR services include, for example, virtual reality (VR), augmented reality (AR), and mixed reality (MR) services. Special services may differ from other services in that they operate on PDU sets, with each PDU set including one or multiple data packets (e.g., internet protocol (IP) packets). Each PDU set may be mapped to the same or different QoS flows, and there can be different numbers of data packets in different PDU sets. A PDU set may also be referred to as an application data unit (ADU).

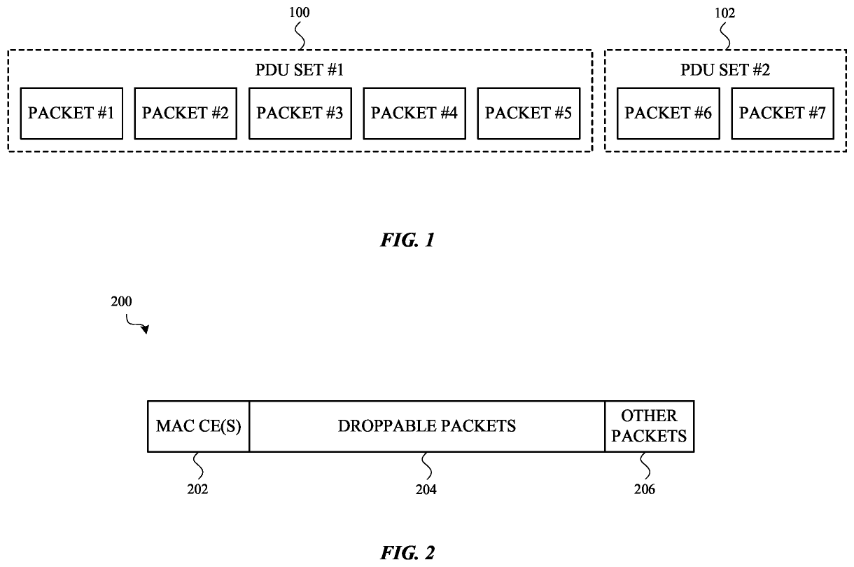

FIG. 1 shows a couple of PDU sets 100, 102 that may be mapped to a QoS flow. By way of example, a first PDU set 100 (PDU Set #1) is shown to include five data packets (PACKETs #1-#5), and a second PDU set 102 (PDU Set #2) is shown to include two data packets (PACKETs #6 and #7). Each PDU set 100, 102 could alternatively have more or fewer data packets, and a QoS flow could alternatively have more or fewer PDU sets.

A user plane function (UPF) may identify a PDU set by means of a PDU set sequence number (SN), an identifier of a starting and/or ending PDU of a PDU set, a PDU SN within a PDU set, and/or a number of PDUs within a PDU set. A QoS flow may be identified by means of a QoS flow identifier (ID). A UPF may further identify information relating to each PDU set, such as a PDU set importance or a PDU set dependency (e.g., an indication of whether use of a PDU set is dependent on a receiver's receipt of another PDU set). A UPF may provide information relating to PDU sets to a RAN.

It has been proposed that new QoS parameters for PDU set-based QoS handling be defined for 5G NR RAT. These new QoS parameters may include, for example, a PDU set delay budget (PSDB); a PDU set error rate (PSER); an indication of whether to drop a PDU set in case its PSDB is exceeded; an indication of whether all data packets in a PDU set need to be received for the PDU set to be used by an application layer; and a PDU set priority.

As a result of the proposed new QoS parameters, it is possible that some data packets of a PDU set may be proactively dropped (discarded) before they are transmitted. For example, data packets may be proactively dropped if the PSDB for a PDU set is exceeded, or data packets may be proactively dropped when it is determined that a data packet was not received but all of the data packets in a PDU set need to be received for the PDU set to be used by an application layer.

More particularly, non-transmitted data packets in a PDU set may be proactively dropped when all of the data packets in a PDU set need to be delivered successfully for the data packets to be used by an application layer, but delivery of one or more of the data packets has already failed. As another example, non-transmitted data packets in a PDU set may be proactively dropped when the delivery of at least one critical or essential data packet in the PDU set has already failed. As another example, non-transmitted data packets in a PDU set may be proactively dropped when a receiver need only receive a particular portion of the data packets in the PDU set for the PDU set to be useful to an application layer (e.g., upon receiving the particular portion of the data packets in the PDU set, the remaining data packets may be dropped/discarded to save power and/or air interface resources). As another example, non-transmitted data packets in a PDU set may be proactively dropped when use of the PDU set depends on the successful delivery of another PDU set, and delivery of the other PDU set has already failed (e.g., the ability of an application layer to use a P-frame PDU set may depend on the successful transmission of an I-frame PDU set).

Proactive packet dropping may be possible when some of the data packets of a PDU set are transmitted at different times, such that some of the data packets may still reside in a packet data convergence protocol (PDCP), radio link control (RLC), MAC, or PHY layer after some of the data packets of the PDU set have already been transmitted. Proactive packet dropping may also be possible when none of the data packets of a PDU set have been transmitted, and the delivery status of another PDU set on which the PDU set depends is already known.

In some cases, some or all of the non-transmitted data packets of a PDU set may have already been passed to a MAC or PHY layer for processing. In some cases, non-transmitted data packets associated with a logical channel (LCH) may have already been mapped to a MAC PDU and multiplexed with data packets of one or more other LCHs, and/or with one or more MAC CEs. In these cases, dropping the entire TB may jeopardize the performance of other traffic flows.

To perform packet dropping at the MAC layer, the hybrid automatic repeat request (HARQ) buffer may be flushed and the Configured Grant timer of the associated HARQ process may be stopped. However, it can be awkward to drop the ongoing transmission of a MAC PDU that includes both data packets that can be dropped and data packets of other traffic flows and/or MAC CEs (the latter of which should not be dropped). On the other hand, maintaining the HARQ operation of such a MAC PDU may be wasteful from an efficiency point of view—especially if the data to be dropped occupies a large portion of the MAC PDU (or TB).

FIG. 2 shows an example MAC PDU 200 (or TB) that may be used to transmit one or more MAC CEs or data packets. By way of example, the MAC PDU 200 includes one or more MAC CEs 202, a large chunk of data 204 (i.e., data packets) that can be dropped, and data 206 of other LCHs or radio bearers that should not be dropped. To drop the data 204, the MAC CE(s) 202 and data 206 would also traditionally need to be dropped.

Described herein are various ways to drop data packets without dropping the data 206 (e.g., by avoiding dropping a MAC PDU such as the one described with reference to FIG. 2), and various ways to drop the data 204 without dropping the data 206 (e.g., by controlling how a MAC PDU is constructed).

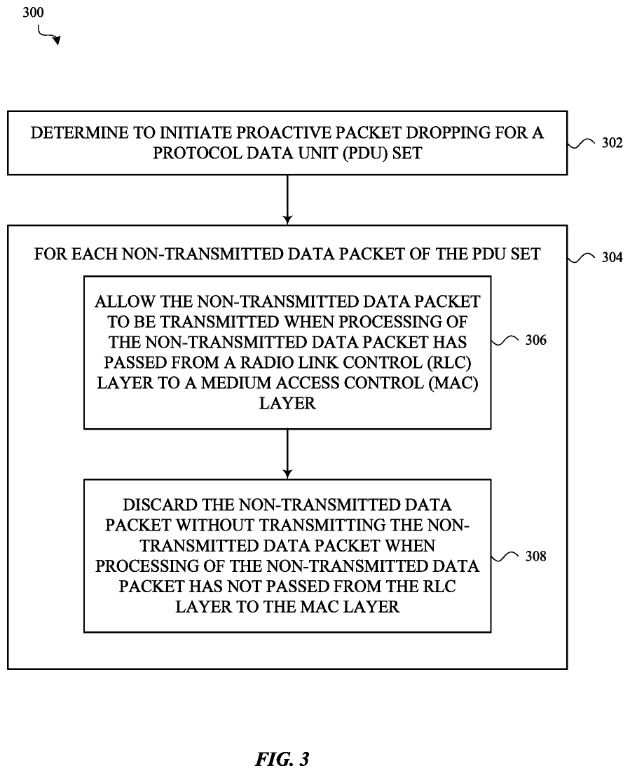

FIG. 3 shows an example method 300 of wireless communication by a UE, which method 300 may be used to proactively drop non-transmitted data packets of a PDU set under some conditions. The method 300 may be performed by a processor of the UE, and transmissions and receptions facilitated by the processor may be made using a transceiver of the UE. Alternatively, the method 300 may be performed by a base station.

At 302, the method 300 may include determining to initiate proactive packet dropping for a PDU set. The reason for determining to initiate proactive packet dropping may be any of the reasons described herein.

At 304, and after (or in response to) the determination to initiate proactive packet dropping for the PDU set, the method 300 may include performing a set of operations for each non-transmitted data packet of the PDU set. The set of operations may be performed for individual ones or sets of data packets of the PDU set.

At 306, the method 300 may include allowing the non-transmitted data packet to be transmitted via the transceiver when processing of the non-transmitted data packet has passed from a radio link control (RLC) layer to a medium access control (MAC) layer. Stated differently, if processing of the non-transmitted data packet has passed from the RLC layer to the MAC layer, the data packet will not be proactively dropped, and MAC or PHY layer processing of the non-transmitted data packet may continue. In some embodiments, the method 300 may include determining that processing of a non-transmitted data packet has passed from the RLC layer to the MAC layer based at least partly on a mapping of the non-transmitted data packet to a MAC PDU, or based at least partly on the non-transmitted data packet being processed by a physical (PHY) layer. For example, if a non-transmitted data packet has been mapped to a MAC PDU or is being processed by the PHY layer, the non-transmitted data packet may be determined to have passed from the RLC layer to the MAC layer.

At 308, the method 300 may include discarding the non-transmitted data packet without transmitting the non-transmitted data packet via the transceiver when processing of the non-transmitted data packet has not passed from the RLC layer to the MAC layer. Stated differently, if processing of the non-transmitted data packet has not passed from the RLC layer to the MAC layer, the data packet will be proactively dropped. In some embodiments, the method 300 may include determining that processing of a non-transmitted data packet has not passed from the RLC layer to the MAC layer based at least partly on the non-transmitted data packet residing in (e.g., being buffered in) an RLC buffer or a packet data convergence protocol (PDCP) buffer. For example, if the non-transmitted data packet resides in the RLC buffer or the PDCP buffer, the non-transmitted data packet may be determined to not have passed from the RLC layer to the MAC layer. In some embodiments, non-transmitted data packets may be proactively dropped (i.e., discarded) by flushing the non-transmitted data packets from the RLC buffer and/or PDCP buffer.

In some embodiments, the method 300 may include transmitting at least a first data packet of the PDU set, and determining to initiate the proactive packet dropping after transmitting at least the first data packet.

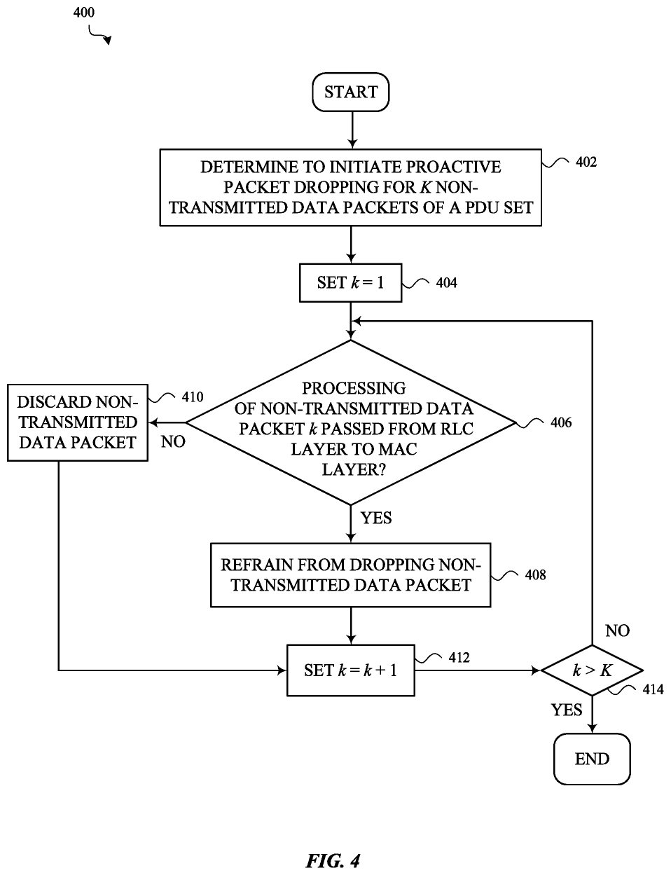

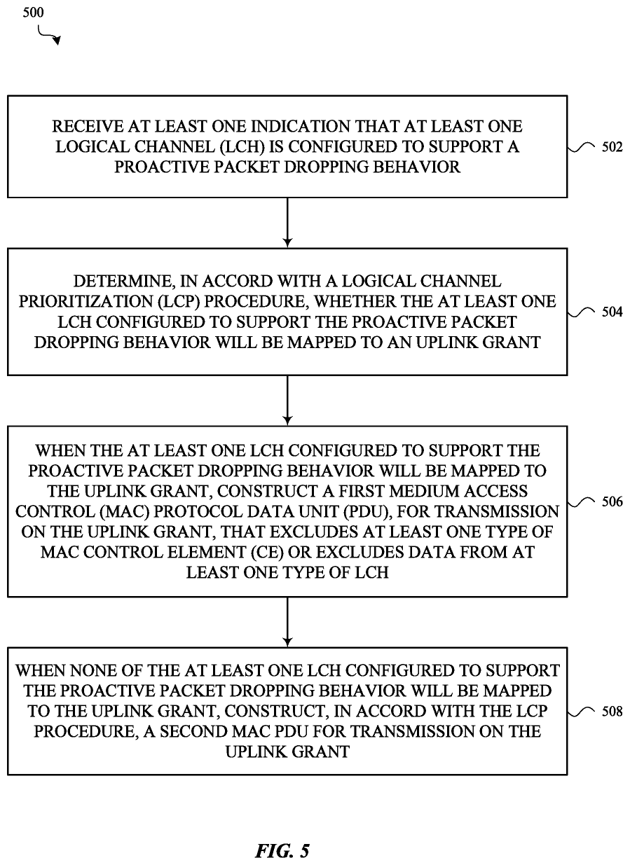

FIG. 4 shows an example implementation 400 of the method described with reference to FIG. 3.

At 402, a UE may determine to initiate proactive packet dropping for a PDU set. At the time the UE determines to initiate proactive packet dropping, there may be K non-transmitted data packets in the PDU set.

At 404, the UE may initialize a counter value, k, to k=1.

At 406, the UE may determine whether processing of the non-transmitted data packet k has passed from an RLC layer to a MAC layer. If yes, the method 400 may continue at 408. If no, the method 400 may continue at 410.

At 408, the UE may allow the non-transmitted data packet to be transmitted. Stated differently, the UE may refrain from proactively dropping/discarding the non-transmitted data packet and allow MAC or PHY layer processing of the non-transmitted data packet to continue.

At 410, the UE may proactively drop/discard the non-transmitted data packet.

At 412, the UE may increment the counter (i.e., set k=k+1).

At 414, the UE may determine if all non-transmitted data packets of the PDU set have been evaluated (i.e., determine if k>K). If yes, the method 400 may end (or continue with additional processing operations (not shown)). If no, the method 400 may return to the operation(s) at 406.

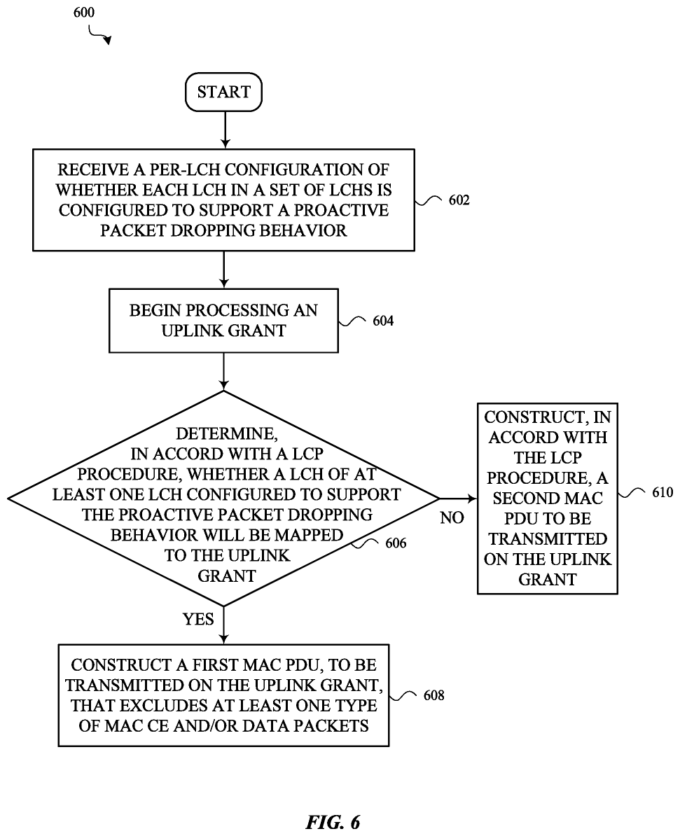

FIG. 5 shows another example method 500 of wireless communication by a UE, which method 500 may be used to support proactive packet dropping behavior for one or more LCHs. The method 500 may be performed by a processor of the UE, and transmissions and receptions facilitated by the processor may be made using a transceiver of the UE. Alternatively, the method 500 may be performed by a base station.

At 502, the method 500 may include receiving at least one indication that at least one LCH is configured to support a proactive packet dropping behavior. The at least one indication may be received via the transceiver of the UE. In some embodiments, the at least one indication may be received in a new “labeling” parameter. For example, the at least one indication may be received in at least one information element (IE) of a logical channel configuration (i.e., at least one IE of logicalChannelConfig). An indication that a LCH supports a proactive packet dropping behavior does not mean that data packets will be proactively dropped from a PDU set transmitted on the LCH. Instead, an indication that a LCH supports a proactive packet dropping behavior means that, when one or more conditions are met, data packets may be potentially proactively dropped from a PDU set transmitted on the LCH.

At 504, 506, and 508, the method 500 may include constructing a MAC PDU based on whether the at least one LCH is configured to support the proactive packet dropping behavior. More particularly, and at 504, the method 500 may include determining, in accord with a logical channel prioritization (LCP) procedure, whether the at least one LCH (i.e., one or more LCH of the at least one LCH) that is configured to support the proactive packet dropping behavior will be mapped to an uplink grant. The determination made at 504 may be made before any decision on whether to actually drop data packets has been made, and may be made based on the potential (or possibility) that data packets may be proactively dropped in the future.

In some embodiments, determining whether the at least one LCH configured to support the proactive packet dropping behavior will be mapped to the uplink grant may include determining whether the uplink grant can convey data of the at least one LCH configured to support the proactive packet dropping behavior. Additionally or alternatively, and in some embodiments, determining whether the at least one LCH configured to support the proactive packet dropping behavior will be mapped to the uplink grant may include determining whether the at least one LCH configured to support the proactive packet dropping behavior can be mapped to the uplink grant and 1) has buffered data, and/or 2) has a priority level higher than any other LCH or combination of LCHs that can be multiplexed on the uplink grant and has buffered data. Additionally or alternatively, and in some embodiments, determining whether the at least one LCH configured to support the proactive packet dropping behavior will be mapped to the uplink grant may include other factors, such as other uplink grant characteristics (e.g., TB size).

At 506, and when the at least one LCH configured to support the proactive packet dropping behavior will be mapped to the uplink grant, the method 500 may include constructing a first MAC PDU, for transmission on the uplink grant, that excludes at least one type of MAC CE and/or excludes data packets from at least one other LCH (e.g., from at least one LCH that is not configured to support the proactive packet dropping). In some embodiments, only higher priority MAC CEs or higher priority data packets (e.g., data packets of higher priority LCHs) may be excluded from the first MAC PDU, so that they do not get proactively dropped. In some embodiments, the first MAC PDU may be constructed such that it only includes data packets of the at least one LCH that is configured to support the proactive packet dropping behavior (e.g., the first MAC PDU may include data packets from one or more LCHs, but may only include data packets from LCHs that are configured to support the proactive packet dropping behavior). In some embodiments, the first MAC PDU may be constructed such that it only includes data packets of a single LCH that is configured to support the proactive packet dropping behavior. In the latter embodiments, it may be easier for a UE to drop/discard data packets for one particular LCH without impacting the transmission of data packets of other LCHs.

In some embodiments, the operation(s) at 506 may include adjusting a LCH setting (e.g., a prioritized bit rate (PBR)) to make sure the radio resources of the uplink grant can be better utilized.

At 508, and when none of the at least one LCH configured to support the proactive packet dropping behavior will be mapped to the uplink grant, the method 500 may include constructing, in accord with the LCP procedure, a second MAC PDU for transmission on the uplink grant. In some embodiments, the operation(s) at 508 may include application of a legacy LCP procedure. In some embodiments, the LCP operations applied at 508 may treat LCHs that are configured to support the proactive packet dropping behavior similar to other LCHs. In some embodiments, the LCP operations applied at 508 may intentionally exclude any LCH that is configured to support the proactive packet dropping behavior.

In some embodiments, the method 500 may include determining, in accord with the LCP procedure, that two or more LCHs of the at least one LCH that are configured to support the proactive packet dropping behavior may be mapped to the uplink grant (e.g., in the case of an XR service with multiple traffic flows). In these cases, and in some embodiments, the method 500 may further include selecting a highest priority LCH from among the two or more LCHs, and constructing the first MAC PDU using data of the selected highest priority LCH. Alternatively, the method 600 may include selecting a LCH having the most buffered data from among the two or more LCHs, and constructing the first MAC PDU using data of the selected LCH having the most buffered data. Alternatively, the method 600 may include selecting a LCH having the oldest buffered data (i.e., data packets that have been queued the longest) from among the two or more LCHs, and constructing the first MAC PDU using data of the selected LCH having the oldest buffered data. Alternatively, the method 600 may otherwise include selecting one LCH from among the two or more LCHs (e.g., based on network or UE implementation), and constructing the first MAC PDU using data of the selected one LCH. Alternatively, the method 600 may include constructing the first MAC PDU by multiplexing, in the first MAC PDU, data from the two or more LCHs.

In some embodiments, the method 500 may include proactively dropping one or more non-transmitted data packets of a PDU set. Proactive packet dropping may be initiated for a variety of reasons, including any of the reasons described herein. In these embodiments, the method 500 may include beginning to construct (or fully constructing) the first MAC PDU. The first MAC PDU may be constructed for at least one PDU set that is mapped to a LCH, which LCH is configured to support a proactive packet dropping behavior. Before transmitting the first MAC PDU via the transceiver, the method 500 may include determining to initiate proactive packet dropping for the PDU set. After the determination to initiate the proactive packet dropping for the PDU set, the method 500 may include dropping the first MAC PDU without transmitting the first MAC PDU via the transceiver. After the determination to initiate the proactive packet dropping for the PDU set, and in some embodiments, the method 500 may also include flushing an RLC buffer or a PDCP buffer for the LCH.

In some embodiments of the method 500, proactively dropping one or more non-transmitted data packets of the PDU set may also include proactively dropping (i.e., discarding) data packets by flushing an RLC buffer and/or PDCP buffer of the UE.

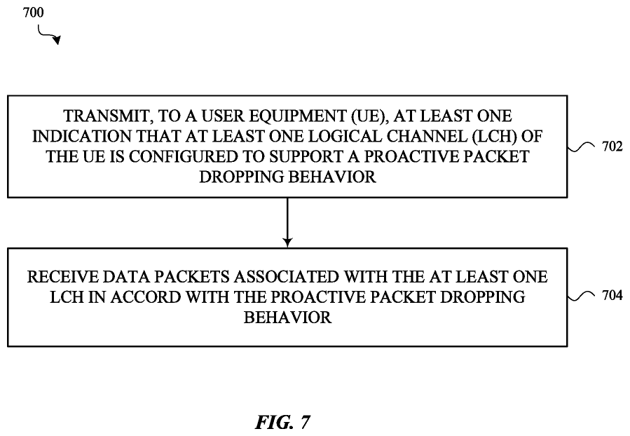

FIG. 6 shows an example implementation of the method 600 described with reference to FIG. 5.

At 602, a UE may receive a per-LCH configuration (i.e., a per-LCH indication) of whether each LCH in a set of LCHs is configured to support, or not support, a proactive packet dropping behavior.

At 604, the UE may begin processing an uplink grant.

At 606, the UE may determine, in accord with a LCP procedure, whether a LCH of at least one LCH that is configured to support the proactive packet dropping behavior will be mapped to the uplink grant. If yes, the method 600 may continue at 608. If no, the method 600 may continue at 610.

At 608, the UE may construct a first MAC PDU, to be transmitted on the uplink grant, that excludes at least one type of MAC CE and/or excludes data packets from at least one type of LCH.

At 610, the UE may construct, in accord with the LCP procedure, a second MAC PDU to be transmitted on the uplink grant.

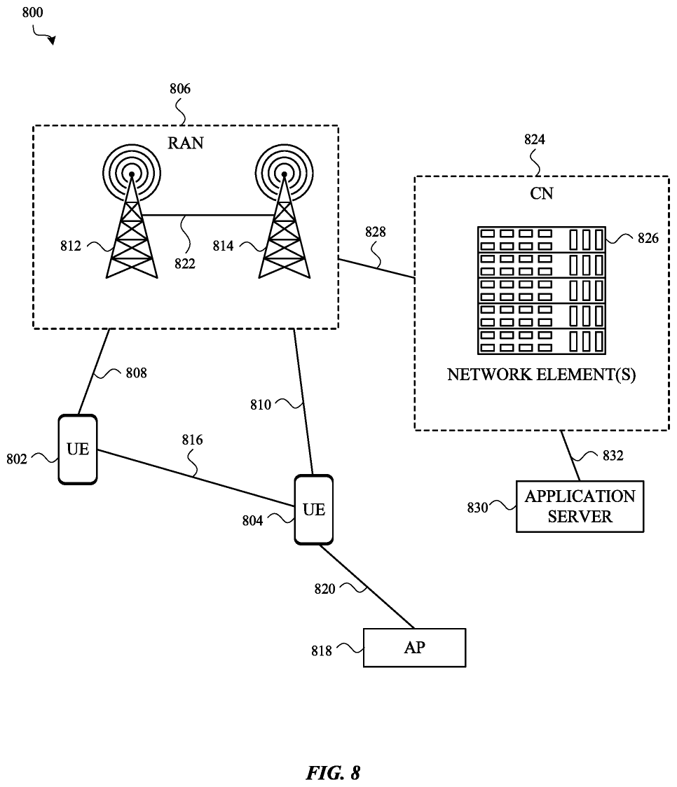

FIG. 7 shows an example method 700 of wireless communication by a base station, which method 700 may be used to support proactive packet dropping behavior for one or more logical channels of a UE.

At 702, the method 700 may include transmitting, to a UE, at least one indication that at least one LCH of the UE is configured to support a proactive packet dropping behavior.

At 704, the method 700 may include receiving data packets associated with the at least one LCH in accord with the proactive packet dropping behavior.

Embodiments contemplated herein include an apparatus having means to perform one or more elements of the method 300, 400, 500, 600, or 700. In the context of method 300, 400, 500, or 600, the apparatus may be, for example, an apparatus of a UE (such as a wireless device 902 that is a UE, as described herein). In the context of method 700, the apparatus may be, for example, an apparatus of a base station (such as a network device 920 that is a base station, as described herein).

Embodiments contemplated herein include one or more non-transitory computer-readable media storing instructions to cause an electronic device, upon execution of the instructions by one or more processors of the electronic device, to perform one or more elements of the method 300, 400, 500, 600, or 700. In the context of method 300, 400, 500, or 600, the non-transitory computer-readable media may be, for example, a memory of a UE (such as a memory 906 of a wireless device 902 that is a UE, as described herein). In the context of method 700, the non-transitory computer-readable media may be, for example, a memory of a base station (such as a memory 924 of a network device 920 that is a base station, as described herein).

Embodiments contemplated herein include an apparatus having logic, modules, or circuitry to perform one or more elements of the method 300, 400, 500, 600, or 700. In the context of method 300, 400, 500, or 600, the apparatus may be, for example, an apparatus of a UE (such as a wireless device 902 that is a UE, as described herein). In the context of method 700, the apparatus may be, for example, an apparatus of a base station (such as a network device 920 that is a base station, as described herein).

Embodiments contemplated herein include an apparatus having one or more processors and one or more computer-readable media, using or storing instructions that, when executed by the one or more processors, cause the one or more processors to perform one or more elements of the method 300, 400, 500, 600, or 700. In the context of method 300, 400, 500, or 600, the apparatus may be, for example, an apparatus of a UE (such as a wireless device 902 that is a UE, as described herein). In the context of the method 700, the apparatus may be, for example, an apparatus of a base station (such as a network device 920 that is a base station, as described herein).

Embodiments contemplated herein include a signal as described in or related to one or more elements of the method 300, 400, 500, 600, or 700.

Embodiments contemplated herein include a computer program or computer program product having instructions, wherein execution of the program by a processor causes the processor to carry out one or more elements of the method 300, 400, 500, 600, or 700. In the context of method 300, 400, 500, or 600, the processor may be a processor of a UE (such as a processor(s) 904 of a wireless device 902 that is a UE, as described herein), and the instructions may be, for example, located in the processor and/or on a memory of the UE (such as a memory 906 of the wireless device 902, as described herein). In the context of method 700, the processor may be a processor of a base station (such as a processor(s) 922 of a network device 920 that is a base station, as described herein), and the instructions may be, for example, located in the processor and/or on a memory of the base station (such as a memory 924 of the network device 920, as described herein).

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations, such as base station 812 and base station 814, that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi® router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

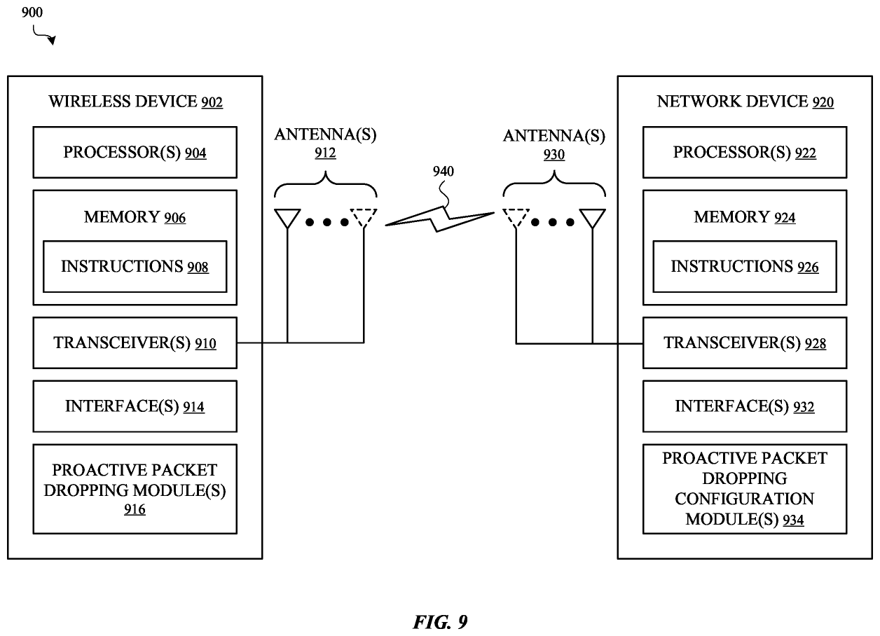

FIG. 9 illustrates a system 900 for performing signaling 940 between a wireless device 902 and a network device 920, according to embodiments disclosed herein. The system 900 may be a portion of a wireless communication system as herein described. The wireless device 902 may be, for example, a UE of a wireless communication system. The network device 920 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter and/or receiver circuitry that use the antenna(s) 912 of the wireless device 902 to facilitate signaling (e.g., the signaling 940) to and/or from the wireless device 902 with other devices (e.g., the network device 920) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi®, Bluetooth®, and the like).

The wireless device 902 may include one or more proactive packet dropping module(s) 916. The proactive packet dropping module(s) 916 may be implemented via hardware, software, or combinations thereof. For example, the proactive packet dropping module(s) 916 may be implemented as a processor, circuit, and/or instructions 908 stored in the memory 906 and executed by the processor(s) 904. In some examples, the proactive packet dropping module(s) 916 may be integrated within the processor(s) 904 and/or the transceiver(s) 910. For example, the proactive packet dropping module(s) 916 may be implemented by a combination of software components (e.g., executed by a DSP or a general processor) and hardware components (e.g., logic gates and circuitry) within the processor(s) 904 or the transceiver(s) 910.

The proactive packet dropping module(s) 916 may be used for various aspects of the present disclosure, for example, aspects of FIGS. 1-7. The proactive packet dropping module(s) 916 may be configured to, for example, determine which LCHs are configured to support proactive packet dropping, cause MAC PDUs to be constructed in a manner that supports proactive packet dropping, and initiate proactive packet dropping when necessary.

The network device 920 may include one or more processor(s) 922. The processor(s) 922 may execute instructions such that various operations of the network device 920 are performed, as described herein. The processor(s) 904 may include one or more baseband processors implemented using, for example, a CPU, a DSP, an ASIC, a controller, an FPGA device, another hardware device, a firmware device, or any combination thereof configured to perform the operations described herein.

The network device 920 may include a memory 924. The memory 924 may be a non-transitory computer-readable storage medium that stores instructions 926 (which may include, for example, the instructions being executed by the processor(s) 922). The instructions 926 may also be referred to as program code or a computer program. The memory 924 may also store data used by, and results computed by, the processor(s) 922.

The network device 920 may include one or more transceiver(s) 928 that may include RF transmitter and/or receiver circuitry that use the antenna(s) 930 of the network device 920 to facilitate signaling (e.g., the signaling 940) to and/or from the network device 920 with other devices (e.g., the wireless device 902) according to corresponding RATs.

The network device 920 may include one or more antenna(s) 930 (e.g., one, two, four, or more). In embodiments having multiple antenna(s) 930, the network device 920 may perform MIMO, digital beamforming, analog beamforming, beam steering, etc., as has been described.

The network device 920 may include one or more interface(s) 932. The interface(s) 932 may be used to provide input to or output from the network device 920. For example, a network device 920 that is a base station may include interface(s) 932 made up of transmitters, receivers, and other circuitry (e.g., other than the transceiver(s) 928/antenna(s) 930 already described) that enables the base station to communicate with other equipment in a core network, and/or that enables the base station to communicate with external networks, computers, databases, and the like for purposes of operations, administration, and maintenance of the base station or other equipment operably connected thereto.

The network device 920 may include one or more proactive packet dropping configuration module(s) 934. The proactive packet dropping configuration module(s) 934 may be implemented via hardware, software, or combinations thereof. For example, the proactive packet dropping configuration module(s) 934 may be implemented as a processor, circuit, and/or instructions 926 stored in the memory 924 and executed by the processor(s) 922. In some examples, the proactive packet dropping configuration module(s) 934 may be integrated within the processor(s) 922 and/or the transceiver(s) 928. For example, the proactive packet dropping configuration module(s) 934 may be implemented by a combination of software components (e.g., executed by a DSP or a general processor) and hardware components (e.g., logic gates and circuitry) within the processor(s) 922 or the transceiver(s) 928.

The proactive packet dropping configuration module(s) 934 may be used for various aspects of the present disclosure, for example, aspects of FIGS. 1-7. The proactive packet dropping configuration module(s) 934 may be configured to, for example, indicate to another device (e.g., the wireless device 902) which LCHs are configured to support proactive packet dropping.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
a transceiver; and
a processor configured to,
receive, via the transceiver, at least one indication that at least one logical channel (LCH) is configured to support a proactive packet dropping behavior; and
construct a medium access control (MAC) protocol data unit (PDU) based on whether the at least one LCH is configured to support the proactive packet dropping behavior.

2. The UE of claim 1, wherein:
the processor is configured to,
determine, in accord with a logical channel prioritization (LCP) procedure, whether the at least one LCH configured to support the proactive packet dropping behavior will be mapped to an uplink grant;
when the at least one LCH configured to support the proactive packet dropping behavior will be mapped to the uplink grant, construct the MAC PDU, for transmission on the uplink grant, to exclude at least one type of MAC control element (CE) or to exclude data packets from at least one type of LCH; or
when none of the at least one LCH configured to support the proactive packet dropping behavior will be mapped to the uplink grant, construct the MAC PDU, in accord with the LCP procedure, for transmission on the uplink grant.

3. The UE of claim 2, wherein the determination of whether the at least one LCH configured to support the proactive packet dropping behavior will be mapped to the uplink grant is based on at least one of:
whether the uplink grant can convey data of the at least one LCH configured to support the proactive packet dropping behavior; or
whether the at least one LCH configured to support the proactive packet dropping behavior can be mapped to the uplink grant and,
has buffered data; or
has a priority level higher than any other LCH or combination of LCHs that can be multiplexed on the uplink grant and has buffered data.

4. The UE of claim 2, wherein:
when the at least one LCH configured to support the proactive packet dropping behavior will be mapped to the uplink grant, construct the MAC PDU to only include data packets of the at least one LCH configured to support the proactive packet dropping behavior.

5. The UE of claim 2, wherein:
the processor is configured to,
determine, in accord with the LCP procedure, that two or more LCHs of the at least one LCH configured to support the proactive packet dropping behavior may be mapped to the uplink grant;
select a highest priority LCH from among the two or more LCHs of the at least one LCH configured to support the proactive packet dropping behavior that may be mapped to the uplink grant; and
construct the MAC PDU using data of the selected highest priority LCH.

6. The UE of claim 2, wherein:
the processor is configured to,
determine, in accord with the LCP procedure, that two or more LCHs of the at least one LCH configured to support the proactive packet dropping behavior may be mapped to the uplink grant;
select a LCH having a most buffered data from among the two or more LCHs of the at least one LCH configured to support the proactive packet dropping behavior that may be mapped to the uplink grant; and
construct the MAC PDU using data of the selected LCH having the most buffered data.

7. The UE of claim 2, wherein:
the processor is configured to,
determine, in accord with the LCP procedure, that two or more LCHs of the at least one LCH configured to support the proactive packet dropping behavior may be mapped to the uplink grant;
select a LCH having an oldest buffered data from among the two or more LCHs of the at least one LCH configured to support the proactive packet dropping behavior that may be mapped to the uplink grant; and
construct the MAC PDU using data of the selected LCH having the oldest buffered data.

8. The UE of claim 2, wherein:
the processor is configured to,
determine, in accord with the LCP procedure, that two or more LCHs of the at least one LCH configured to support the proactive packet dropping behavior may be mapped to the uplink grant;
select one LCH from among the two or more LCHs of the at least one LCH configured to support the proactive packet dropping behavior that may be mapped to the uplink grant; and
construct the MAC PDU using data of the selected one LCH.

9. The UE of claim 2, wherein:
the processor is configured to,
determine, in accord with the LCP procedure, that two or more LCHs of the at least one LCH configured to support the proactive packet dropping behavior may be mapped to the uplink grant; and
multiplex, in the MAC PDU, data from the two or more LCHs of the at least one LCH configured to support the proactive packet dropping behavior.

10. The UE of claim 2, wherein:
the processor is configured to,
begin constructing the MAC PDU for a PDU set that is mapped to the at least one LCH configured to support the proactive packet dropping behavior;
before transmitting the MAC PDU via the transceiver, determine to initiate proactive packet dropping for the PDU set; and
after the determination to initiate the proactive packet dropping for the PDU set, drop the MAC PDU without transmitting the MAC PDU via the transceiver.

11. The UE of claim 10, wherein:
the processor is configured to,
after the determination to initiate the proactive packet dropping for the PDU set, flush an RLC buffer or a packet data convergence protocol (PDCP) buffer for the at least one LCH configured to support the proactive packet dropping behavior.

12. The UE of claim 1, wherein the at least one LCH configured to support the proactive packet dropping behavior is mapped to an extended reality (XR) service traffic flow.

13. The UE of claim 1, wherein the at least one indication that the at least one LCH is configured to support the proactive packet dropping behavior is received in at least one information element (IE) of logicalChannelConfig.

14. A method of wireless communication by a user equipment (UE), comprising:
receiving at least one indication that at least one logical channel (LCH) is configured to support a proactive packet dropping behavior;
determining, in accord with a logical channel prioritization (LCP) procedure, whether the at least one LCH configured to support the proactive packet dropping behavior will be mapped to an uplink grant;
when the at least one LCH configured to support the proactive packet dropping behavior will be mapped to the uplink grant, constructing a first medium access control (MAC) protocol data unit (PDU), for transmission on the uplink grant, that excludes at least one type of MAC control element (CE) or excludes data from at least one type of LCH; or
when none of the at least one LCH configured to support the proactive packet dropping behavior will be mapped to the uplink grant, constructing, in accord with the LCP procedure, a second MAC PDU for transmission on the uplink grant.

15. The method of claim 14, wherein determining whether the at least one LCH configured to support the proactive packet dropping behavior will be mapped to the uplink grant comprises at least one of:
determining whether the uplink grant can convey data of the at least one LCH configured to support the proactive packet dropping behavior; or
determining whether the at least one LCH configured to support the proactive packet dropping behavior can be mapped to the uplink grant and,
has buffered data; or
has a priority level higher than any other LCH that can be multiplexed on the uplink grant and has buffered data.

16. The method of claim 14, wherein:
when the at least one LCH configured to support the proactive packet dropping behavior will be mapped to the uplink grant, constructing the first MAC PDU, to be transmitted on the uplink grant, to only include data of the LCH of the at least one LCH configured to support the proactive packet dropping behavior.

17. A user equipment (UE), comprising:
a transceiver; and
a processor configured to,
determine to initiate proactive packet dropping for a protocol data unit (PDU) set; and
after the determination to initiate proactive packet dropping for the PDU set, and for each non-transmitted data packet of the PDU set,
allow the non-transmitted data packet to be transmitted via the transceiver when processing of the non-transmitted data packet has passed from a radio link control (RLC) layer to a medium access control (MAC) layer; or
discard the non-transmitted data packet without transmitting the non-transmitted data packet via the transceiver when processing of the non-transmitted data packet has not passed from the RLC layer to the MAC layer.

18. The UE of claim 17, wherein:
the processor is configured to,
transmit at least a first data packet of the PDU set via the transceiver; and
determine to initiate dropping after transmission of the at least first data packet.

19. The UE of claim 17, wherein:
the processor is configured to,
determine that processing of the non-transmitted data packet has not passed from the RLC layer to the MAC layer based at least partly on the non-transmitted data packet residing in an RLC buffer or a packet data convergence protocol (PDCP) buffer.

20. The UE of claim 17, wherein:
the processor is configured to,
determine that processing of the non-transmitted data packet has passed from the RLC layer to the MAC layer based at least partly on a mapping of the non-transmitted data packet to a MAC PDU or a processing of the non-transmitted data packet by a physical (PHY) layer.
